(19) United States
(12) Patent Application Publication
(10) Pub. No.: US 2025/0068468 A1
(43) Pub. Date: Feb. 27, 2025

(54) MEMORY POOLING CONFIGURATION SYSTEM, METHOD, ELECTRONIC DEVICE, AND STORAGE MEDIUM

(71) Applicant: Alibaba Innovation Private Limited, Singapore (SG)

(72) Inventors: Tianchan GUAN, Shanghai (CN); Dimin NIU, Sunnyvale, CA (US); Yijin GUAN, Beijing (CN); Zhaoyang DU, Beijing (CN); Hongzhong ZHENG, Los Gatos, CA (US)

(21) Appl. No.: 18/813,688

(22) Filed: Aug. 23, 2024

(30) Foreign Application Priority Data
Aug. 25, 2023 (CN) 202311082716.6

(51) Int. Cl. G06F 9/50

(52) U.S. Cl. CPC G06F 9/5016

(57) ABSTRACT

A memory pooling configuration system includes: a plurality of servers, an expansion switch in communication with the plurality of servers, and a memory configuration device. A target server acquires first memory pooling configuration information, which instructs the target server to send a second memory access request to the expansion switch when a virtual address indicated by a first memory access request does not correspond to a physical address space of the target server. The expansion switch acquires third memory pooling configuration information, which instructs the expansion switch to forward the second memory access request to an associated server based on the second memory access request. The associated server acquires second memory pooling configuration information, which instructs the associated server to return the memory access result of the second memory access request to the expansion switch, which forwards the memory access result to the target server.

### CROSS-REFERENCE TO RELATED APPLICATIONS

This application claims priority to Chinese Patent Application No. 202311082716.6, filed with the China National Intellectual Property Administration on Aug. 25, 2023, and entitled “Memory Pooling Configuration System, Method, Electronic Device, and Storage Medium,” which is incorporated herein by reference in its entirety.

### TECHNICAL FIELD

The embodiments of the present invention relate to the field of computer technology, and more particularly, to a memory pooling configuration system, method, electronic device, and storage medium.

### BACKGROUND

A cloud computing system includes a certain number of servers, which, as physical servers, can also be referred to as hosts or host servers. Utilizing virtualization technology, several virtual machines can be flexibly configured within a server. These virtual machines operate independently of each other to execute specific elastic computing tasks or distributed computing tasks. In some cases, remaining memory resources of a server are insufficient to construct a current virtual machine, resulting in a certain amount of memory resource fragmentation.

In conventional solutions for memory resource fragmentation, each host in the cloud computing system is equipped with a memory expansion device. However, this approach still brings numerous issues. For example, the large number of hosts in the cloud computing system increases the overall cost of the system. Additionally, it is challenging to estimate the required memory resources for the memory expansion devices when configuring the cloud computing system. The configuration of virtual machines within the cloud computing system may change over time, leading to the possibility that memory expansion devices may either be unnecessary or still insufficient in terms of memory resources.

### SUMMARY

In view of this, embodiments of the present invention provide a memory pooling configuration system, method, electronic device, and storage medium to at least partially solve the above-mentioned problems.

According to a first aspect of the embodiments of the present invention, a memory pooling configuration system is provided, including: a memory configuration device; a plurality of servers in communication with the memory configuration device; and an expansion switch in communication with the plurality of servers and the memory configuration device. A target server among the plurality of servers obtains first memory pooling configuration information from the memory configuration device. The first memory pooling configuration information instructs the target server to send the second memory access request to the expansion switch when the virtual address indicated by the first memory access request does not correspond to the physical address space of the target server. The expansion switch obtains third memory pooling configuration information from the memory configuration device. The third memory pooling configuration information instructs the expansion switch to determine an associated server among the plurality of servers associated with the target server based on the second memory access request, and forward the second memory access request to the associated server. The associated server obtains second memory pooling configuration information from the memory configuration device. The second memory pooling configuration information instructs the associated server to return the memory access result of the second memory access request to the expansion switch, so that the expansion switch forwards the memory access result to the target server.

In other embodiments of the present invention, the first memory pooling configuration information also instructs the target server to directly return the memory access result of the first memory access request when the virtual address indicated by the first memory access request corresponds to the physical address space of the target server.

In other embodiments of the present invention, the first memory pooling configuration information includes a first address mapping table. The first address mapping table indicates the mapping relationship between the virtual address space of the target server and the extended physical address space of the target server. The extended physical address space includes the physical address space of the target server and is larger than the physical address space of the target server indicated by the target server. The target server is specifically configured to: determine the physical address corresponding to the virtual address indicated by the first memory access request within the extended physical address space, and send a second memory access request that includes the physical address to the expansion switch. The expansion switch determines the associated server associated with the physical address based on a second address mapping table and includes the physical address in the second memory access request.

In other embodiments of the present invention, the expansion switch obtains third memory pooling configuration information from the memory configuration device. The third memory pooling configuration information includes the second address mapping table.

In other implementation of the present invention, the third memory pooling configuration information includes the second address mapping table. The third memory pooling configuration information instructs the expansion switch to determine the actual physical address space, which includes the physical address, based on the second address mapping table and to identify the server with the actual physical address space from among the plurality of servers as the associated server.

In other implementation of the present invention, the memory configuration device determines the first memory pooling configuration information, the second memory pooling configuration information, and the third memory pooling configuration information based on an idle resource status of the plurality of servers. The idle resource status includes access latency between each server and the expansion switch and/or remaining memory resources of each server.

In other implementations of the present invention, the first memory pooling configuration information instructs the target server to include the virtual address in the second memory access request when the virtual address indicated by the first memory access request does not correspond to the preset address mapping table of the target server. The second memory pooling configuration information instructs to execute the memory access of the virtual address based on a preset mapping table of the associated server to obtain the memory access result of the second memory access request.

According to a second aspect of the embodiments of the present invention, a memory pooling configuration method is provided, including: sending first memory pooling configuration information to a target server among a plurality of servers, where the first memory pooling configuration information instructs the target server to send the second memory access request to the expansion switch when the virtual address indicated by the first memory access request does not correspond to the physical address space of the target server; sending third memory pooling configuration information to the expansion switch, where the third memory pooling configuration information instructs the expansion switch to determine an associated server among the plurality of servers associated with the target server based on the second memory access request and forwards the second memory access request to the associated server; and sending second memory pooling configuration information to the associated server, wherein the second memory pooling configuration information instructs the associated server to return the memory access result of the second memory access request, and the third memory pooling configuration information instructs the associated server to forward the memory access result to the target server.

According to a third aspect of the embodiments of the present invention, an electronic device is provided, including: a processor, a memory, a communication interface, and a communication bus. The processor, the memory, and the communication interface communicate with each other via the communication bus. The communication interface is configured to communicate with a plurality of servers and an expansion switch. The memory is configured to store at least one executable instruction, which, when executed by the processor, causes the processor to perform the operations corresponding to the method described in the second aspect.

According to a fourth aspect of the embodiments of the present invention, a computer storage medium is provided. The computer storage medium stores a computer program which, when executed by a processor, implements the method described in the second aspect.

In the embodiments of the present invention, the configuration of the target server and the associated server is achieved through the first memory pooling configuration information and the second memory pooling configuration information, and the configuration of the expansion switch is achieved through the third memory pooling configuration information. When the virtual address indicated by the first memory access request does not correspond to the physical address space of the target server, the memory of the associated server of the target server can be accessed through the expansion switch, and the access result is returned to the target server. In other words, the associated server of the target server among the plurality of servers provides memory resources to the target server via the expansion switch, thereby avoiding the problem of poor flexibility in memory expansion devices. Furthermore, the target server, associated server, and expansion switch are configured independently by the memory configuration device, eliminating the need for the target server to determine the associated server, thereby enhancing the flexibility of memory pooling configuration.

### BRIEF DESCRIPTION OF THE DRAWINGS

In order to more clearly illustrate the technical solutions in the embodiments of the present invention or the prior art, the drawings required for the description of the embodiments or the prior art will be briefly introduced below. It is evident that the drawings described below are merely some embodiments of the present invention, and for those of ordinary skill in the art, other drawings can be obtained based on these drawings.

FIG. 1A is a schematic block diagram of a memory pooling configuration system according to an example.

FIG. 1B is a schematic block diagram of a memory pooling configuration system according to another example.

FIG. 2 is a schematic block diagram of a memory pooling configuration system according to an embodiment of the present invention.

FIG. 3 is a schematic block diagram of the memory pooling configuration system according to the embodiment in FIG. 2.

FIGS. 4A-4C are schematic block diagrams of memory pooling configuration systems according to other embodiments of the present invention.

FIG. 5 is a flowchart of steps in the memory pooling configuration method according to the present invention.

FIG. 6 is a schematic structural diagram of an electronic device according to other embodiments of the present invention.

### DETAIL DESCRIPTION OF THE EMBODIMENTS

To enable those skilled in the art to better understand the technical solutions in the embodiments of the present invention, the technical solutions in the embodiments of the present invention will be clearly and completely described below in conjunction with the accompanying drawings of the embodiments of the present invention. It is evident that the described embodiments are only some of the embodiments of the present invention and not all embodiments. All other embodiments obtained by a person of ordinary skill in the art based on the embodiments of the present invention shall fall within the scope of protection of the embodiments of the present invention.

The embodiments of the present invention will be further described below in conjunction with the accompanying drawings of the embodiments.

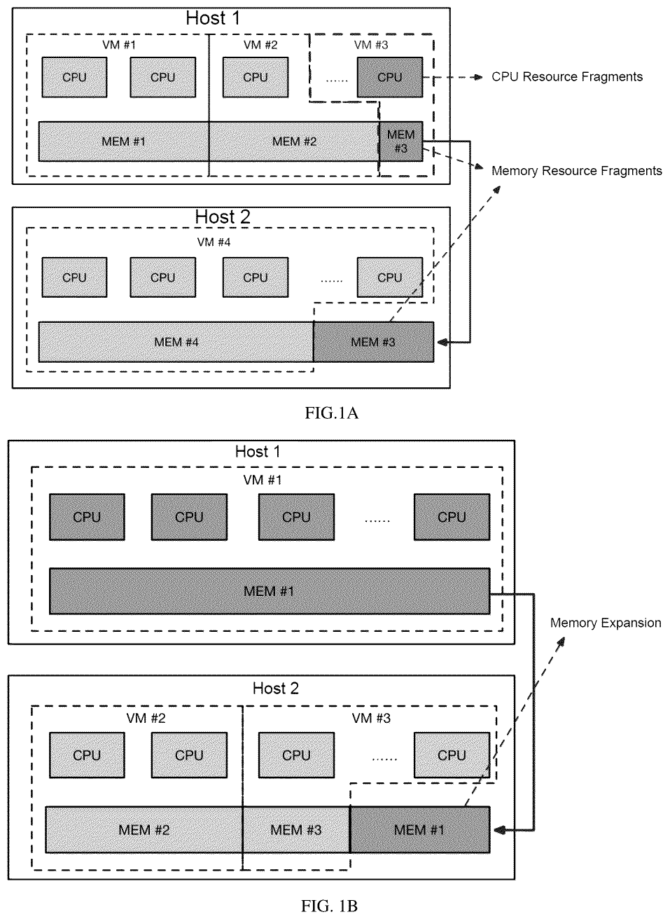

FIG. 1A is a schematic block diagram of a memory pooling configuration system according to one example. In the memory pooling configuration system of FIG. 1A, the host includes a virtualization layer, a manager, and a resource scheduler. The virtualization layer is used to manage physical resources and divide them into multiple virtual machines. The virtualization layer is responsible for allocating computing resources such as CPU, memory, and storage space to meet user requests. The manager is used to manage the virtual machine resources on the host and dynamically adjust resource allocation according to user demands. The manager also monitors the status and performance of the host to maintain system stability and high availability. The resource scheduler is responsible for optimizing the allocation and utilization of resources to ensure efficient use of system resources and maximize performance.

The network card is a critical component in a cloud computing system that connects hosts and assists in data transmission between them. Each host can be equipped with a network card, which are interconnected through a high-speed network to enable fast data transfer and communication. The network card includes a network interface, data transmission protocol capabilities, and a router. The network interface connects the host to the internal network of the cloud computing system. The network card can be a physical network card or a virtual network card, the latter typically being implemented through software to support a virtualized environment. The data transmission protocol is used to facilitate data transmission between hosts, ensuring the security and integrity of the data. Routers forward data packets to the target host, ensuring the accuracy and efficiency of data transmission.

Each hosts can configure a certain number of virtual machines based on actual conditions. For example, Host 1 is configured with Virtual Machine VM #1, Virtual Machine VM #2, and Virtual Machine VM #3, while Host 2 includes Virtual Machine VM #4. Furthermore, Virtual Machine VM #1 includes Memory MEN #1 and CPU, Virtual Machine VM #2 includes Memory MEN #2 and CPU, and Virtual Machine VM #3 includes Memory MEN #3 and CPU. Virtual Machine VM #4 includes Memory MEN #4 and CPU. Memory MEN #1 and Memory MEN #2 utilize the memory resources of Host 1, and Memory MEN #4 utilizes the memory resources of Host 2. Memory MEN #3 is part of Virtual Machine VM #3, which belongs to Host 1, and Memory MEN #3 utilizes the memory resources of both Host 1 and Host 2. In other words, through the virtualization of resources such as CPU and memory of Host 1, Virtual Machine VM #1 and Virtual Machine VM #2 are obtained. However, the remaining resources of Host 1 are insufficient to fully realize Virtual Machine VM #3, leading to the creation of CPU resource fragments and memory resource fragments, such as Memory MEN #3, in Host 1.

For example, in the memory pooling configuration system shown in FIG. 1B, Host 1 is configured with Virtual Machine VM #1, while Host 2 includes Virtual Machine VM #2 and Virtual Machine VM #3. Furthermore, Virtual Machine VM #1 includes Memory MEN #1 and CPU, Virtual Machine VM #2 includes Memory MEN #2 and CPU, and Virtual Machine VM #3 includes Memory MEN #3 and CPU. The memory resources required by Virtual Machine VM #1 exceed the memory resources available from Host 1 itself. Therefore, Memory MEN #1 includes not only the memory resources of Host 1 but also occupies the memory resources of Host 2.

In traditional solutions for addressing memory resource fragmentation, memory expansion devices are configured for each host in the cloud computing system. However, this approach still presents several issues: for example, the large number of hosts in a cloud computing system increases the overall cost of the system; the memory resources required by the memory expansion devices during the configuration of the cloud computing system are difficult to estimate; and the configuration of virtual machines in the cloud computing system may change over time. Consequently, there is a possibility that memory expansion devices may be either unnecessary or still insufficient in terms of memory resources.

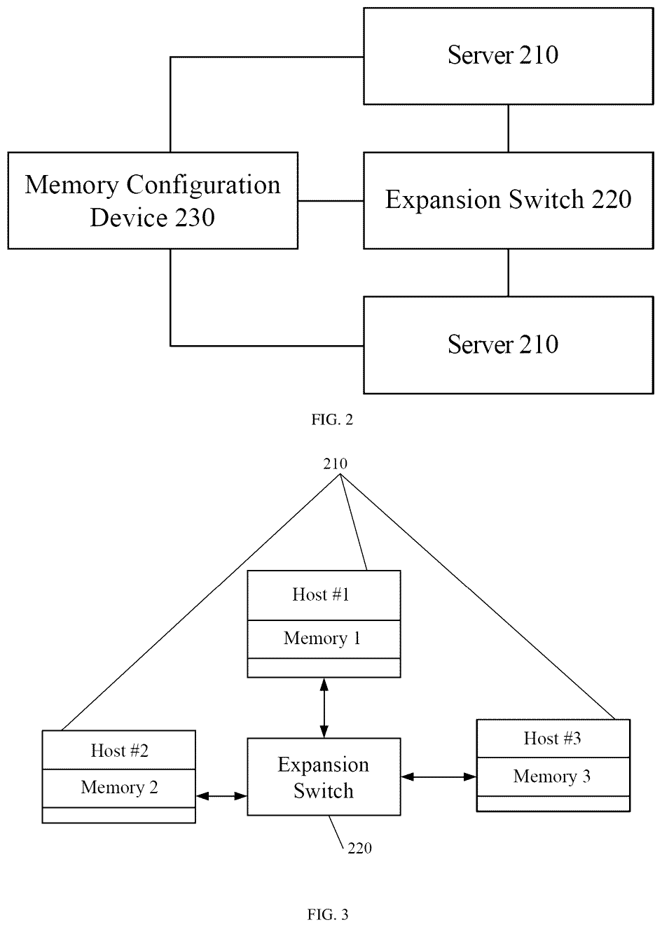

FIG. 2 is a schematic block diagram of a memory pooling configuration system according to an embodiment of the present invention. The memory pooling configuration system of FIG. 2 includes a plurality of servers 210, an expansion switch 220 connected to the plurality of servers 210, and a memory configuration device 230.

It should be understood that each server 210 may be connected to the expansion switch 220 via the same or different communication buses. The communication buses include, but are not limited to, CXL buses, PCIe buses, or Ethernet.

The target server among the plurality of servers 210 obtains first memory pooling configuration information from the memory configuration device 230. The first memory pooling configuration information instructs the target server to send a second memory access request to the expansion switch 220 when the virtual address indicated by a first memory access request does not correspond to the physical address space of the target server.

It should be understood that the servers mentioned herein are physical servers, and each physical server can be configured with at least one virtual machine using virtualization technology. Each virtual machine within the same physical server uses the computing resources (e.g., CPU, GPU, etc.) or memory resources of that physical server. The target server can be any server among the plurality of servers, and an associated server can be any server among the plurality of servers that is different from the target server. The target server's associated server can be one or more servers. The embodiment does not limit this configuration.

It should also be understood that the memory configuration device 230 can be deployed independently of the plurality of servers 210 and the expansion switch 220. Alternatively, the memory configuration device 230 can be deployed in any of the servers 210 or in the expansion switch 220.

When performing memory access, the first memory access request includes the virtual address to be accessed. The host determines the physical address corresponding to the virtual address by looking up its own address mapping table, thereby performing data read or write operations directly or indirectly based on the physical address.

For example, the first memory pooling configuration information can indicate the correspondence between the target server and its associated server, as well as a memory pooling mode. The memory pooling mode can be a fine-grained memory pooling mode or a coarse-grained memory pooling mode.

In the fine-grained memory pooling mode, the physical address space of the memory of the associated server can be contiguous with the physical address space of the memory of the target server.

In the coarse-grained memory pooling mode, the physical address space of the memory of the associated server is different from that of the target server. This means that the memory of the target server and the memory of the associated server have different address mapping tables, such as an inherent address mapping table of each server.

Additionally, the first memory pooling configuration information is compatible with inherent memory access capabilities of the target server. Specifically, the first memory pooling configuration information also instructs the target server to directly return the memory access result of the first memory access request when the physical address indicated by the first memory access request belongs to the target server.

The expansion switch 220 obtains third memory pooling configuration information from the memory configuration device 230. The third memory pooling configuration information instructs the expansion switch to determine, based on the second memory access request, the associated server among the plurality of servers that is linked to the target server, and to forward the second memory access request to the associated server.

For example, the expansion switch may be configured with a memory allocation module to route the second memory access request.

The associated server obtains second memory pooling configuration information. The second memory pooling configuration information instructs the associated server to return the memory access result of the second memory access request to the expansion switch 220, which then forwards the memory access result to the target server.

For example, the second memory pooling configuration information can indicate the correspondence between the target server and its associated server, as well as the memory pooling mode.

It should be understood that the first memory pooling configuration information and the second memory pooling configuration information correspond to each other. Using the first and second memory pooling configuration information, the target server and the associated server can be configured to use the same address mapping table or different address mapping tables.

In the embodiments of the present invention, the configuration of the target server and associated server is achieved through the first and second memory pooling configuration information, and the configuration of the expansion switch is achieved through the third memory pooling configuration information. When the virtual address indicated by the first memory access request does not correspond to the physical address space of the target server, the expansion switch can access the memory of the target server's associated server and return the access result to the target server. In other words, the associated server of the target server provide memory resources to the target server via the expansion switch, thereby avoiding the issue of poor flexibility associated with memory expansion devices. Additionally, the target server, associated server, and expansion switch are independently configured by the memory configuration device, eliminating the need for the target server to determine the associated server, thus enhancing the flexibility of memory pooling configuration.

FIG. 3 is a schematic block diagram of the memory pooling configuration system according to the embodiment shown in FIG. 2. In this embodiment, Host #1, Host #2, and Host #3 are examples of servers 210. Host #1 includes Memory 1, meaning Host #1 can construct its virtual machines using the resources of Memory 1. Host #2 includes Memory 2, allowing Host #2 to construct its virtual machines using the resources of Memory 2. Host #3 includes Memory 3, enabling Host #3 to construct its virtual machines using the resources of Memory 3.

Specifically, the memory configuration device 230 determines the first memory pooling configuration information, second memory pooling configuration information, and third memory pooling configuration information based on an idle resource status of the plurality of servers 210. The idle resource status includes access latency between each server 210 and the expansion switch 220 and/or remaining memory resources of each server 210. For example, the higher the bandwidth indicated by bandwidth parameters of the communication bus between the server and the expansion switch, or the greater the amount of remaining memory resources of the server, the higher the priority of the expansion switch in identifying the server as an associated server for the target server.

In some examples, the memory configuration device can be deployed in the expansion switch, enabling faster monitoring of the communication status between each server and the expansion switch (e.g., current communication bandwidth) without requiring each server to report its communication status. Additionally, each server can report its current remaining memory resources to the memory configuration device.

In other examples, in the fine-grained memory pooling mode, the memory configuration device calculates the total memory resources of the plurality of servers and generates the first address mapping table based on the total memory resources. The memory configuration device then sends the first address mapping table to each server through the first memory pooling configuration information. It should be understood that the target server can be any server among the plurality of servers. When the target server determines that the physical address based on the first address mapping table is not within the target server's physical address space, it sends a first memory access request, which is essentially a memory space allocation request. The memory configuration device determines the associated server for the target server based on the idle resource status, allocates the memory resources of the memory allocation threshold from the associated server, and configures these memory resources into the third memory pooling configuration information. It should be understood that the associated server is the server among the plurality of servers with the most remaining memory resources and the largest communication bandwidth with the expansion switch.

Furthermore, after data written to the contiguous physical address space is read out, if the memory resources from which the data was read reach the memory release threshold, this portion of the memory space can be released. Additionally, if the server that released the memory resources has an associated server, the memory configuration device can use the third memory pooling configuration information to swap the memory resources in the associated server with the released memory resources (i.e., remove the associated server's swapped physical address space from the second address mapping table). This allows the server to minimize requests for the associated server's memory resources, thereby improving data access efficiency. If, after the memory resource swap, the requested memory resources do not exist in the associated server, the third memory pooling configuration information can be used to delete the association between the server and the associated server.

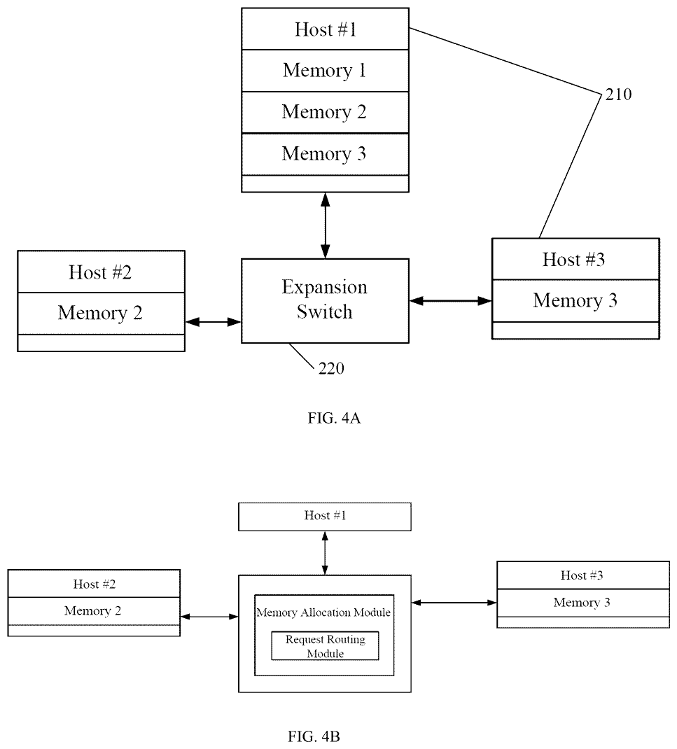

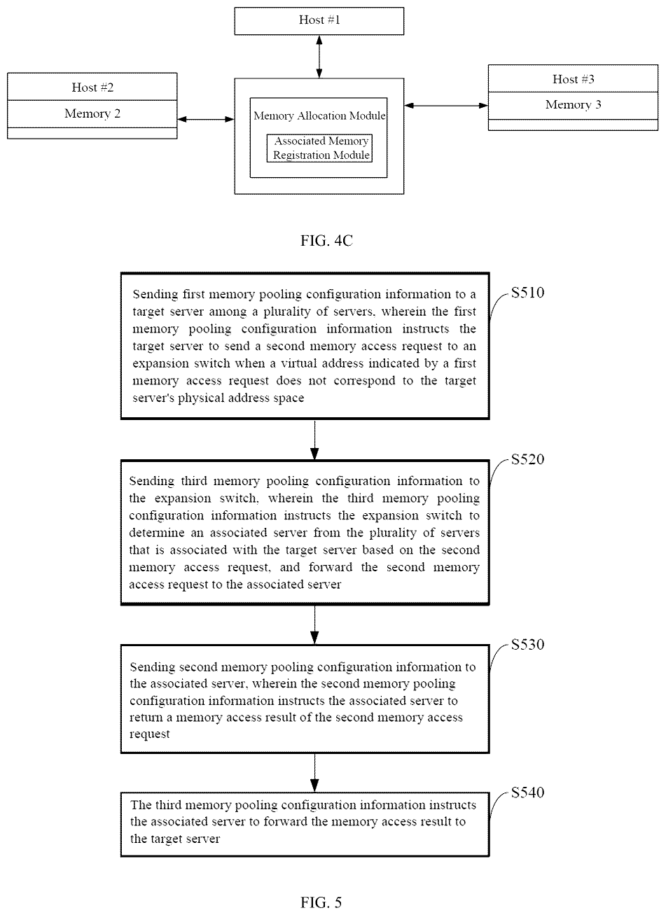

Furthermore, in the example shown in FIG. 4A, Host #2 and Host #3 are associated servers of Host #1, allowing Host #1 to access the memory of Host #2 and Host #3 through the expansion switch 220. The expansion switch 220 can be configured with a memory allocation module, which is used to allocate memory between the target server and the associated servers, enabling cross-server memory allocation when configuring virtual machines within the servers.

In other examples, the first memory pooling configuration information includes the first address mapping table, which indicates the mapping relationship between the virtual address space of the target server and the extended physical address space of the target server. The extended physical address space includes the physical address space of the target server and is larger than the physical address space of the target server indicated by the target server. Specifically, the target server is used to: determine the physical address corresponding to the virtual address indicated by the first memory access request and send a second memory access request, including the physical address, to the expansion switch. The expansion switch, based on the second address mapping table, determines the associated server linked to the physical address and includes the physical address in the second memory access request. As shown in FIG. 4B, the memory allocation module includes a request routing module. The request routing module can route the second memory access request to the associated server corresponding to the physical address. For example, the request routing module stores the mapping relationship between the physical address spaces of the memories of a plurality of associated servers and the physical address space of the target server and/or the identifiers of the associated servers. In the fine-grained memory pooling mode, the request routing module parses the second memory access request to obtain the physical address that does not correspond to the physical address space of the target server (i.e., the physical address that exceeds the physical address space of the target server but is within the extended physical space of the target server). Using the second address mapping table, the request routing module determines the identifier of the associated server to be accessed based on the physical address and then forwards the second access request to this associated server to perform the access operation. It should be understood that the embodiment shown in FIG. 4B can be an example of fine-grained memory allocation.

In other examples, the second memory pooling configuration information includes the second address mapping table, which indicates the mapping relationship between the virtual address space of the associated server and the physical address space of the associated server. Specifically, the target server is used to forward the first memory access request to the expansion switch as a second memory access request when the virtual address included in the first memory access request does not belong to the target server's virtual address space. The associated server is used to generate the physical address corresponding to the virtual address based on the second address mapping table and generate the memory access result based on the physical address.

Generally, the third memory pooling configuration information includes the second address mapping table. The third memory pooling configuration information instructs the expansion switch to determine the actual physical address space that includes the physical address based on the second address mapping table and to identify the server with the actual physical address space as the associated server from among the plurality of servers.

Furthermore, in the coarse-grained memory pooling mode, the first memory pooling configuration information instructs the target server to include the virtual address in the second memory access request when the virtual address indicated by the first memory access request does not correspond to the target server's preset address mapping table. The second memory pooling configuration information instructs the associated server to perform the memory access for the virtual address based on its preset mapping table, thereby obtaining the memory access result for the second memory access request.

In other words, in the coarse-grained memory pooling mode, each server (including the target server and associated servers) maintains its own preset address mapping table. The memory configuration device does not need to change each server's preset address mapping table when performing memory pooling configuration. As shown in FIG. 4C, the memory allocation module includes an associated memory registration module, which can register the identifiers of the associated servers. It should be understood that the identifiers of the associated servers represent the memory of the associated servers to distinguish it from the memory of other servers. In this example, the physical address space of each server's (i.e., host's) memory is independent. That is to say, each server's memory uses an independent address mapping table. Memory pooling configuration is achieved through the relationship between the associated servers and the target server.

Furthermore, FIG. 5 illustrates a memory pooling configuration method according to the present invention. The memory pooling configuration method, which can be executed by the memory configuration device 230, includes the following steps:
S510: sending the first memory pooling configuration information to a target server among a plurality of servers, wherein the first memory pooling configuration information instructs the target server to send a second memory access request to an expansion switch when a virtual address indicated by a first memory access request does not correspond to the target server's physical address space;
S520: sending third memory pooling configuration information to the expansion switch, wherein the third memory pooling configuration information instructs the expansion switch to determine an associated server from the plurality of servers that is associated with the target server based on the second memory access request, and forward the second memory access request to the associated server;
S530: sending second memory pooling configuration information to the associated server, wherein the second memory pooling configuration information instructs the associated server to return a memory access result of the second memory access request; and
S540: the third memory pooling configuration information instructs the associated server to forward the memory access result to the target server.

It should be understood that each server 210 may be connected to the expansion switch 220 via the same or different communication buses. The communication buses include, but are not limited to, CXL buses, PCIe buses, or Ethernet.

The target server among the plurality of servers 210 obtains the first memory pooling configuration information from the memory configuration device 230. The first memory pooling configuration information instructs the target server to send a second memory access request to the expansion switch 220 when the virtual address indicated by the first memory access request does not correspond to the physical address space of the target server.

It should be understood that the servers mentioned herein are physical servers, and each physical server can be configured with at least one virtual machine using virtualization technology. Each virtual machine within the same physical server uses the computing resources (e.g., CPU, GPU, etc.) or memory resources of that physical server. The target server can be any server among the plurality of servers, and an associated server can be any server among the plurality of servers that is different from the target server. The target server can have one or more associated servers. The embodiment does not limit this configuration.

It should also be understood that the memory configuration device 230 can be deployed independently of the plurality of servers 210 and the expansion switch 220. Alternatively, the memory configuration device 230 can be deployed in any of the servers 210 or in the expansion switch 220.

Data read and write operations are performed based on the physical address.

For example, the first memory pooling configuration information can indicate the correspondence between the target server and its associated servers, as well as the memory pooling mode. The memory pooling mode can be a fine-grained memory pooling mode or a coarse-grained memory pooling mode.

In the fine-grained memory pooling mode, the physical address space of the memory of the associated server can be contiguous with the physical address space of the memory of the target server.

In the coarse-grained memory pooling mode, the physical address space of the memory of the associated server is different from that of the target server. This means that the target server's memory and the associated server's memory have different address mapping tables, such as the inherent address mapping table of each server.

Additionally, the first memory pooling configuration information is compatible with the inherent memory access capabilities of the target server. Specifically, the first memory pooling configuration information instructs the target server to directly return the memory access result of the first memory access request when the physical address indicated by the first memory access request belongs to the target server.

For example, the expansion switch can be configured with a memory allocation module to route the second memory access request.

The associated server obtains the second memory pooling configuration information. The second memory pooling configuration information instructs the associated server to return the memory access result of the second memory access request to the expansion switch 220, which then forwards the memory access result to the target server.

For example, the second memory pooling configuration information can indicate the correspondence between the target server and its associated servers, as well as the memory pooling mode.

It should be understood that the first memory pooling configuration information and the second memory pooling configuration information correspond to each other. Through the first and second memory pooling configuration information, the target server and the associated servers can be configured to use the same address mapping table or different address mapping tables.

In the embodiments of the present invention, the configuration of the target server and associated server is achieved through the first and second memory pooling configuration information, and the configuration of the expansion switch is achieved through the third memory pooling configuration information. When the virtual address indicated by the first memory access request does not correspond to the physical address space of the target server, the expansion switch can access the memory of the target server's associated server and return the access result to the target server. In other words, the associated server of the target server provide memory resources to the target server via the expansion switch, thereby avoiding the issue of poor flexibility associated with memory expansion devices. Additionally, the target server, associated server, and expansion switch are independently configured by the memory configuration device, eliminating the need for the target server to determine the associated server, thus enhancing the flexibility of memory pooling configuration.

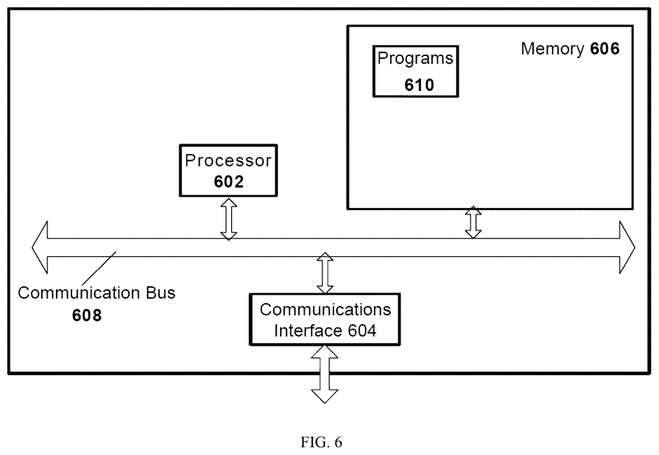

Referring to FIG. 6, a schematic structural diagram of an electronic device according to another embodiment of the present invention is shown. The specific implementation of the electronic device is not limited in the embodiments of the present invention. The electronic device can be the aforementioned expansion switch.

As shown in FIG. 6, the electronic device may include: a processor 602 for executing programs 610, a communications interface 604, a memory 606, and a communication bus 608.

The processor, communications interface, and memory communicate with each other through the communication bus.

The communications interface is used for communication with a plurality of servers and the expansion switch.

The processor is used for executing programs, specifically to execute the relevant steps in the method embodiments described above.

Specifically, the programs may include program code, which includes computer operation instructions.

The processor may be a CPU, an Application Specific Integrated Circuit (ASIC), or one or more integrated circuits configured to implement one or more embodiments of the present invention. The intelligent device may include one or more processors, which can be of the same type, such as one or more CPUs; or of different types, such as one or more CPUs and one or more ASICs.

The memory is used to store programs. The memory may include high-speed RAM, and may also include non-volatile memory, such as at least one disk storage.

The program may include multiple computer instructions, which can specifically enable the processor to perform the operations corresponding to the memory pooling configuration method as described in any of the preceding method embodiments.

The specific implementation of each step in the program can refer to the corresponding descriptions in the respective steps and units of the aforementioned method embodiments and have the corresponding beneficial effects. For the sake of convenience and brevity, the specific working processes of the described devices and modules can refer to the corresponding process descriptions in the aforementioned method embodiments, and will not be redundantly described here. It is clear to those skilled in the art that the specific working processes of the described devices and modules can be understood by referring to the corresponding processes in the aforementioned method embodiments.

The embodiments of the present invention also provide a computer storage medium storing a computer program, which, when executed by a processor, implements the method described in any of the aforementioned method embodiments. The computer storage medium includes but is not limited to: Compact Disc Read-Only Memory (CD-ROM), Random Access Memory (RAM), floppy disks, hard disks, or magneto-optical disks.

Additionally, it should be noted that the user-related information (including but not limited to user device information, personal information, etc.) and data (including but not limited to sample data for model training, data for analysis, stored data, displayed data, etc.) involved in the embodiments of the present invention are all information and data authorized by the user or fully authorized by the relevant parties. The collection, use, and processing of such data must comply with relevant regulations and standards, and appropriate operational entry points should be provided for users to choose whether to authorize or refuse.

It should be noted that, as needed for implementation, the various components/steps described in the embodiments of the present invention can be split into more components/steps, or two or more components/steps or parts of their operations can be combined into new components/steps to achieve the objectives of the embodiments of the present invention.

The methods according to the embodiments of the present invention can be implemented in hardware, firmware, or as software or computer code stored on a recording medium (such as CD-ROM, RAM, floppy disk, hard disk, or magneto-optical disk). Alternatively, they can be realized as computer code initially stored in remote recording media or non-transitory machine-readable media and downloaded over a network to be stored in local recording media. Thus, the described methods can be stored on such recording media using general-purpose computers, dedicated processors, or programmable or dedicated hardware (such as Application Specific Integrated Circuits (ASICs) or Field Programmable Gate Arrays (FPGAs)).

It is understood that a computer, processor, microprocessor controller, or programmable hardware includes storage components (such as Random Access Memory (RAM), Read-Only Memory (ROM), flash memory, etc.) that can store or receive software or computer code. When this software or computer code is accessed and executed by the computer, processor, or hardware, it implements the methods described herein. Furthermore, when a general-purpose computer accesses code designed to implement the methods shown here, the execution of the code transforms the general-purpose computer into a specialized computer for executing the methods illustrated.

It will be appreciated by those skilled in the art that the units and method steps of the various examples described in connection with the embodiments disclosed herein can be implemented in electronic hardware, or a combination of computer software and electronic hardware. Whether these functions are executed as hardware or software depends on the specific application and design constraints of the technical solution. Skilled professionals may use different methods to implement the described functions for specific applications, but such implementations should not be considered as going beyond the scope of the embodiments of the present invention.

The above embodiments are merely illustrative of the embodiments of the present invention and are not intended to limit the scope of the invention. Those skilled in the relevant technical field can make various changes and modifications without departing from the spirit and scope of the embodiments of the present invention. Therefore, all equivalent technical solutions should also be considered within the scope of the embodiments of the present invention. The scope of patent protection for the embodiments of the present invention should be defined by the claims.

What is claimed is:

1. A memory pooling configuration system, comprising:
a memory configuration device;
a plurality of servers in communication with the memory configuration device;
an expansion switch in communication with the plurality of servers and the memory configuration device,
wherein a target server of the plurality of servers acquires first memory pooling configuration information from the memory configuration device, the first memory pooling configuration information instructing the target server to send a second memory access request to the expansion switch when a virtual address indicated by a first memory access request does not correspond to a physical address space of the target server;
the expansion switch acquires third memory pooling configuration information from the memory configuration device, the third memory pooling configuration information instructing the expansion switch to determine, based on the second memory access request, an associated server among the plurality of servers associated with the target server and to forward the second memory access request to the associated server; and
the associated server acquires second memory pooling configuration information from the memory configuration device, the second memory pooling configuration information instructing the associated server to return a memory access result of the second memory access request to the expansion switch, causing the expansion switch to forward the memory access result to the target server.

2. The system according to claim 1, wherein the first memory pooling configuration information further instructs the target server to directly return a memory access result of the first memory access request when a virtual address indicated by the first memory access request corresponds to a physical address space of the target server.

3. The system according to claim 1, wherein the first memory pooling configuration information includes a first address mapping table, the first address mapping table indicating a mapping relationship between a virtual address space of the target server and an extended physical address space of the target server, the extended physical address space including the physical address space of the target server, the extended physical address space being larger than the physical address space of the target server indicated by the target sever;
wherein the target server is configured to:
determine a physical address corresponding to the virtual address indicated by the first memory access request within the extended physical address space; and
send the second memory access request, including the physical address, to the expansion switch;
wherein the expansion switch, based on a second address mapping table, determines an associated server associated with the physical address and includes the physical address in the second memory access request.

4. The system according to claim 3, wherein the expansion switch acquires the third memory pooling configuration information from the memory configuration device, the third memory pooling configuration information including the second address mapping table.

5. The system according to claim 4, wherein the third memory pooling configuration information instructs the expansion switch, based on the second address mapping table, to determine an actual physical address space that includes the physical address and to identify, among the plurality of servers, the server having the actual physical address space as the associated server.

6. The system according to claim 4, wherein the memory configuration device determines the first memory pooling configuration information, the second memory pooling configuration information, and the third memory pooling configuration information based on an idle resource status of the plurality of servers, wherein the idle resource status includes access latency between each server and the expansion switch and/or remaining memory resources of each server.

7. The system according to claim 1, wherein the first memory pooling configuration information instructs the target server to include the virtual address in the second memory access request when the virtual address indicated by the first memory access request does not correspond to the preset address mapping table of the target server; wherein the second memory pooling configuration information instructs to execute memory access of the virtual address based on a preset mapping table of the associated server to obtain the memory access result of the second memory access request.

8. A method for configuring memory pooling, comprising:
sending first memory pooling configuration information to a target server among a plurality of servers, wherein the first memory pooling configuration information instructs the target server to send a second memory access request to an expansion switch when a virtual address indicated by a first memory access request does not correspond to the target server's physical address space;
sending third memory pooling configuration information to the expansion switch, wherein the third memory pooling configuration information instructs the expansion switch to determine an associated server from the plurality of servers that is associated with the target server based on the second memory access request and forward the second memory access request to the associated server;
sending second memory pooling configuration information to the associated server, wherein the second memory pooling configuration information instructs the associated server to return a memory access result of the second memory access request, and the third memory pooling configuration information instructs the associated server to forward the memory access result to the target server.

9. The method according to claim 8, wherein the first memory pooling configuration information further instructs the target server to directly return a memory access result of the first memory access request when a virtual address indicated by the first memory access request corresponds to a physical address space of the target server.

10. The method according to claim 8, wherein the first memory pooling configuration information includes a first address mapping table, the first address mapping table indicating a mapping relationship between a virtual address space of the target server and an extended physical address space of the target server, the extended physical address space including the physical address space of the target server, the extended physical address space being larger than the physical address space of the target server indicated by the target sever;
wherein the target server is configured to:
determine a physical address corresponding to the virtual address indicated by the first memory access request within the extended physical address space; and
send the second memory access request, including the physical address, to the expansion switch.

11. The method according to claim 10, wherein the expansion switch determines an associated server associated with the physical address and includes the physical address in the second memory access request.

12. The method according to claim 11, wherein the third memory pooling configuration information includes a second address mapping table, which includes a mapping relationship between virtual address spaces of the associated server and physical address spaces of the associated server.

13. The method according to claim 12, wherein the third memory pooling configuration information instructs the expansion switch, based on the second address mapping table, to determine an actual physical address space that includes the physical address and to identify, among the plurality of servers, the server having the actual physical address space as the associated server.

14. The method according to claim 8, wherein the first memory pooling configuration information, the second memory pooling configuration information, and the third memory pooling configuration information are determined based on an idle resource status of the plurality of servers, wherein the idle resource status includes access latency between each server and the expansion switch and/or remaining memory resources of each server.

15. The method according to claim 8, wherein the first memory pooling configuration information instructs the target server to include the virtual address in the second memory access request when the virtual address indicated by the first memory access request does not correspond to the preset address mapping table of the target server; wherein the second memory pooling configuration information instructs to execute memory access of the virtual address based on a preset mapping table of the associated server to obtain the memory access result of the second memory access request.

16. An electronic device comprising:
one or more processors; and
one or more computer-readable memories coupled to the one or more processors and having instructions stored thereon that are executable by the one or more processors to perform one or more operations comprising:
sending first memory pooling configuration information to a target server among a plurality of servers, wherein the first memory pooling configuration information instructs the target server to send a second memory access request to an expansion switch when a virtual address indicated by a first memory access request does not correspond to the target server's physical address space;
sending third memory pooling configuration information to the expansion switch, wherein the third memory pooling configuration information instructs the expansion switch to determine an associated server from the plurality of servers that is associated with the target server based on the second memory access request and forward the second memory access request to the associated server;
sending second memory pooling configuration information to the associated server, wherein the second memory pooling configuration information instructs the associated server to return a memory access result of the second memory access request, and the third memory pooling configuration information instructs the associated server to forward the memory access result to the target server.

17. The electronic device according to claim 16, wherein the first memory pooling configuration information further instructs the target server to directly return a memory access result of the first memory access request when a virtual address indicated by the first memory access request corresponds to a physical address space of the target server.

18. The electronic device according to claim 16, wherein the first memory pooling configuration information includes a first address mapping table, the first address mapping table indicating a mapping relationship between a virtual address space of the target server and an extended physical address space of the target server, the extended physical address space including the physical address space of the target server, the extended physical address space being larger than the physical address space of the target server indicated by the target sever;
wherein the target server is configured to:
determine a physical address corresponding to the virtual address indicated by the first memory access request within the extended physical address space; and
send the second memory access request, including the physical address, to the expansion switch.

19. The electronic device according to claim 18, wherein the expansion switch determines an associated server associated with the physical address and includes the physical address in the second memory access request.

20. The electronic device according to claim 16, wherein the third memory pooling configuration information includes a second address mapping table, which includes a mapping relationship between virtual address spaces of the associated server and physical address spaces of the associated server, the third memory pooling configuration information instructing the expansion switch, based on the second address mapping table, to determine an actual physical address space that includes the physical address and to identify, among the plurality of servers, the server having the actual physical address space as the associated server.
